(19) United States
(12) Patent Application Publication
(10) Pub. No.: US 2007/0252998 A1
(43) Pub. Date: Nov. 1, 2007

(54) Apparatus for continuous readout of fabry-perot fiber optic sensor

(76) Inventors: John W. Berthold, Salem, OH (US); Seth A. Cocking, Washington, TX (US); Wincenty A. Kaminski, The Woodlands, TX (US); Larry A. Jeffers, Minerva, OH (US); Richard L. Lopushansky, The Woodlands, TX (US)

Correspondence Address: MCDONALD HOPKINS LLC, 600 Superior Avenue, East, Suite 2100, CLEVELAND, OH, 44114-2653, US

(21) Appl. No.: 11/726,273

(22) Filed: Mar. 21, 2007

Related U.S. Application Data
(60) Provisional application No. 60/784,881, filed on Mar. 22, 2006.

(51) Int. Cl. G01J 5/08

(52) U.S. Cl. 356/450; 250/227.11

(57) ABSTRACT

An apparatus to interrogate one or more fiber optic sensors to make high-resolution measurements at long distances between the sensor and the interrogator apparatus. The apparatus comprises a tunable light source, an optical switch for pulsing the light source, at least one sensor (e.g., a Fabry-Perot sensor) for reflecting the laser light, a fiber optic cable interconnecting the sensor with the light source, a coupler for directing the reflected light from the sensor to a detector in order to generate a digital output, and a control logic for tuning the laser light source based on the digital output from the detector. Use of a fiber Bragg grating temperature sensor is also contemplated.

### CROSS-REFERENCE TO RELATED APPLICATION

This application claims priority from U.S. Provisional Patent Application No. 60/784,881 entitled “APPARATUS FOR CONTINUOUS READOUT OF FABRY-PEROT FIBER OPTIC SENSOR” filed on Mar. 22, 2006, which is hereby incorporated by reference in its entirety. This application also claims priority from U.S. patent application Ser. No. 11/105,651 entitled “METHOD AND APPARATUS FOR CONTINUOUS READOUT OF FABRY-PEROT FIBER OPTIC SENSOR” filed on Apr. 14, 2005, which is hereby incorporated by reference in its entirety.

### FIELD OF THE INVENTION

The present invention is generally related to fiber optic sensor systems, and more particularly, an apparatus to interrogate one or more fiber optic sensors to make high-resolution measurements at long distances between the sensor and the interrogator apparatus.

### BACKGROUND OF THE INVENTION

U.S. patent application Ser. No. 11/105,651, titled Method and Apparatus for Continuous Readout of Fabry-Perot Fiber Optic Sensor, describes a method for readout of a Fabry-Perot fiber optic sensor. The method enables use of a Fabry-Perot fiber optic pressure transducer with signal conditioning system that includes a tunable laser. The high power, tunable laser provides rapid switching in fine increments in narrow wavelength bands with repeatability in the infrared spectral band from 1500 nm to 1600 nm. By operating in the 1500 nm to 1600 nm spectral band where attenuation in optical fiber is very low, high-resolution pressure and temperature measurements can be made using Fabry-Perot sensors at remote distances in excess of 10000 meters.

Additional information will be set forth in the description which follows, and in part will be obvious from the description, or may be learned by practice of the invention.

### SUMMARY OF THE INVENTION

The present invention is directed to an apparatus for making high-resolution measurements at long distances between at least one sensor and the apparatus. The apparatus comprises a laser light source that is tunable over a range of frequencies, an optical switch for pulsing the laser light, and at least one sensor for reflecting the laser light. The apparatus also comprises a fiber optic cable that interconnects the sensor with the laser source, means for directing the reflected light from the sensor to a detector in order to generate a digital output, and a control logic for tuning the laser light source based on the digital output from the detector.

The invention is also directed to an apparatus for making high-resolution measurements at long distances between at least two sensors and the apparatus. The apparatus comprises a laser light source that is tunable over a range of frequencies, an optical switch for pulsing the laser light, and a first sensor and a second sensor for reflecting the laser light. The apparatus also comprises a length of fiber optic cable that interconnects the first and second sensors and the laser light source, where the cable delays the reflected light from the second sensor due to the length of the cable. In addition, the apparatus comprises means for directing the reflected light from the first sensor and the delayed reflected light from the second sensor to a detector to generate a digital output, and a control logic for tuning the laser light source based on the digital output.

Finally, the invention is directed to an apparatus for making high-resolution measurements at long distances from at least two sensors and the apparatus. The apparatus comprises a laser light source that is tunable over a range of frequencies, an optical switch for pulsing the laser light and directing the laser light into any one of N output channels, and a first sensor and a second sensor for reflecting the laser light connected via a fiber optic cable to a first output channel and a second output channel respectively. The apparatus also comprises a first length of fiber optic cable interconnecting the first sensor and the first output, and a second length of fiber optic cable interconnecting the second sensor and the second output, where the first length is greater than the second length, and the difference in length is associated with a delay of the reflected laser light of the first sensor. In addition, the apparatus comprises means for directing the reflected light from the first sensor and the delayed reflected light from the second sensor to a detector to generate a digital output, and a control logic for tuning the laser based on the digital output.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings. It is to be understood that both the foregoing general description and the following detailed description are exemplary and explanatory and are intended to provide further explanation of the invention as claimed.

### DESCRIPTION OF THE DRAWINGS

Operation of the invention may be better understood by reference to the following detailed description taken in connection with the following illustrations, wherein:

FIG. 1A is a block diagram of an interrogator apparatus for a Fabry-Perot sensor system.

FIG. 1B is a block diagram of an alternate embodiment for an interrogator apparatus that shows a 1×3 optical switch for a Fabry-Perot sensor system.

FIG. 2 is a spectral reflectance graph of a fiber Bragg grating having points superimposed on the continuous spectrum representing discrete frequencies of the tunable laser. As shown, the spacing between frequency steps is 8.33 GHz.

FIG. 3 is a spectral reflectance graph of a Fabry-Perot pressure sensor spectrum with a sensor gap of 80•m having points superimposed on the continuous spectrum representing discrete frequencies of the tunable laser. R1 and R2 are the respective reflectance from the inside surface of the window and diaphragm shown in FIG. 4A.

FIG. 4A is a diagrammatical representation of a pressure sensor.

FIG. 4B is a diagram of a light pulse used to interrogate the FBG sensor.

FIG. 5 is a graphical representation of reflected intensity I_{R}(•, G) versus frequency for gap G=60062 nm.

FIG. 6 is a graphical representation of reflected intensity of I_{R}(•, G) versus frequency for various gaps G.

FIG. 7 is a graphical representation of sensor gap versus frequency difference in Δv in MHz.

FIG. 8 is a schematic of an alternate embodiment using a delay line, Fabry-Perot temperature sensor and Fabry-Perot pressure sensor.

### DETAILED DESCRIPTION

While the present invention is described with reference to the embodiments described herein, it should be clear that the present invention should not be limited to such embodiments. Therefore, the description of the embodiments herein is illustrative of the present invention and should not limit the scope of the invention as claimed.

The present invention relates to an embodiment for apparatus to interrogate one or more fiber optic sensors to make high-resolution temperature and/or pressure measurements at long distances between the sensor(s) and the interrogator apparatus.

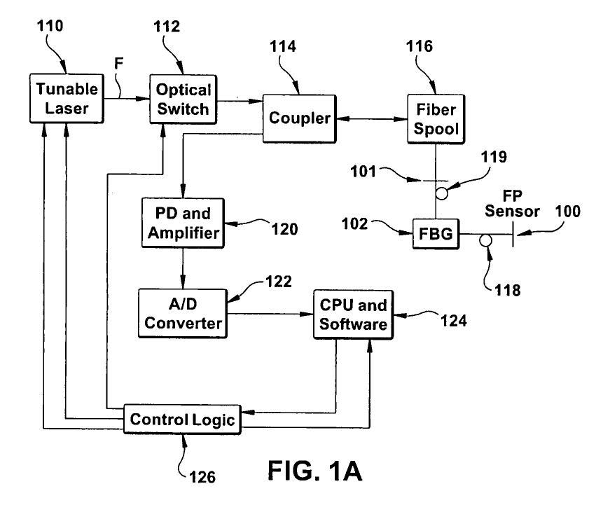

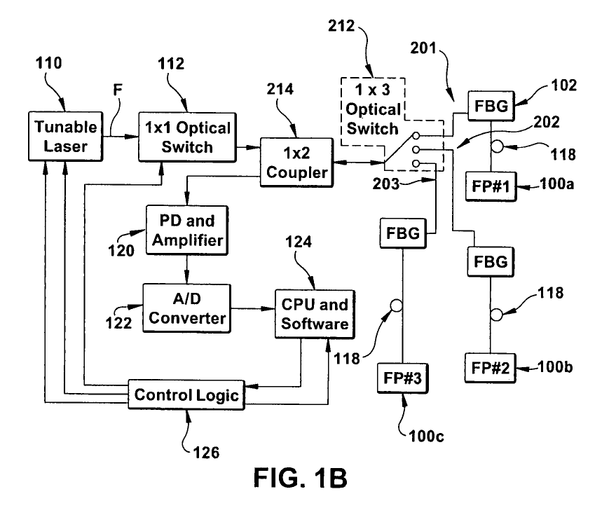

A block diagram of the configuration is shown in FIG. 1A. Infrared light from the laser 110 is injected into a single mode optical fiber F (9 μm core/125 μm clad for example), passes through an optical switch 112, a power splitter 114, a spool of a long length of optical fiber 116, and thence to two sensors—a fiber Bragg grating sensor (FBG) 102 for temperature measurement and a Fabry-Perot sensor (FP) 100 for pressure measurement. Alternatively, an embedded 4% reflector 101 could be used in place of or in addition to the FBG 102. The embedded reflector would provide a means for signal normalization from both the FBG 102 and the FP sensor 100. The embedded reflector 101 and the FBG 102 are separated from the FP 100 by a 100 meter long delay line of optical fiber 118. When the embedded reflector 101 and FBG 102 are both employed, a second delay line 119 is required between the embedded reflector 101 and the FBG 102. The delay line assures that the signals from the embedded reflector 101, the FBG 102 and the FP 100 do not interfere with one another during the detection and peak and valley location process. Although an FBG sensor is shown in series with an FP sensor for simplicity, the system could also be configured with more than one FBG sensor 102 and more than one FP sensor 100. A discussion of this simplified configuration is presented below. The laser 110 tuning range is ˜40 nm wide (1529 nm to 1568 nm) which is wide enough that both the FBG and FP sensors 102, 100 may be interrogated at two different wavelength bands within the tuning range. Infrared light is reflected from the sensors FP, FBG 100, 102 back to an InGaAs photodiode detector 120 (PD) where the light signal is converted to a photocurrent, amplified, digitized in an analog-to-digital (A/D) converter 122 and sent to a processor unit 124 (CPU) where software converts the modulated light signals from the FBG and FP sensors 102, 100 into engineering units for temperature and pressure. The output of the temperature sensor can be used to correct the pressure sensor output for temperature dependent changes in the pressure sensor gap.

Numerous methods are available to turn the light on and off. Some of these include a fast optical switch, electro-optic modulator, or a simple electronic circuit to switch on and off the electric current to the laser. An optical switch 112 is used as shown in FIG. 1A. The optical switch 112 has a turn-on time of 300 ns and a turn-off time of time of 300 ns.

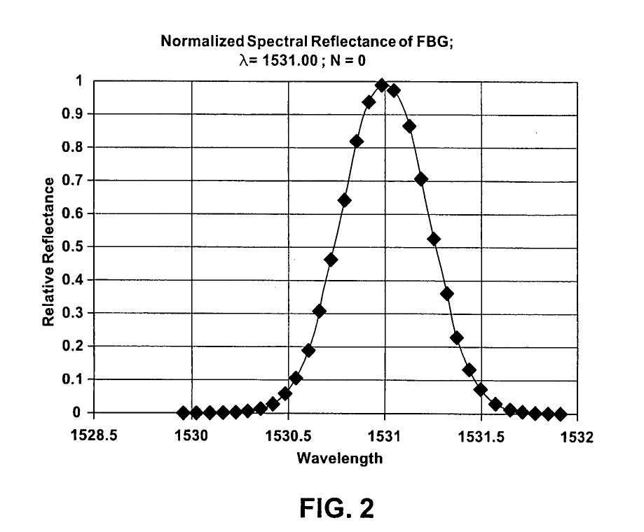

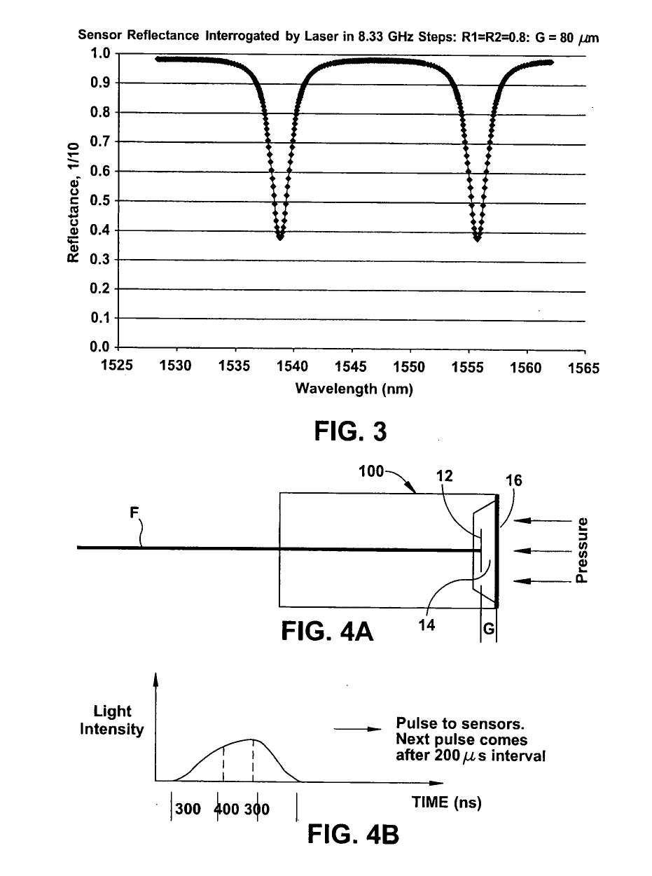

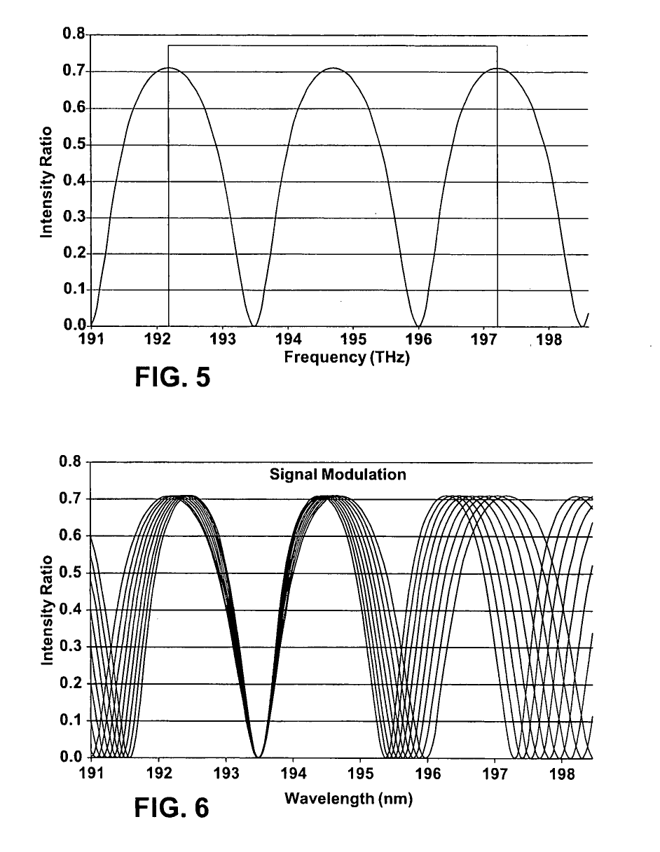

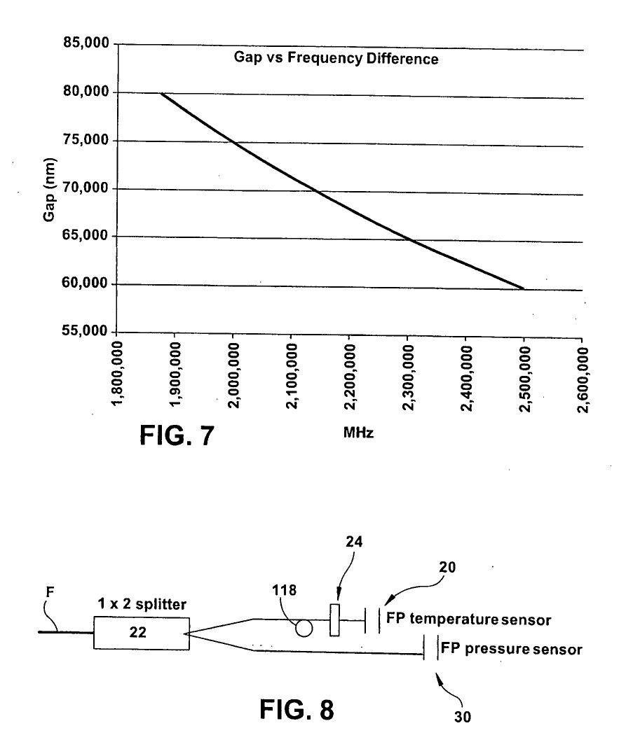

The purpose of the control logic 126 is two-fold. First, the control logic 126 is used to tune the laser 110 to find the wavelength location of the peak of the FBG 102 (FIG. 2) and the valleys of two Fabry-Perot peaks (FIG. 3). Second, the control logic 126 must turn the optical switch 112 on to allow laser light 110 to pass to the sensors FP, FBG, 100, 102 and turn the light off so that laser light scattered by the optical fiber F does not interfere with measurements of the sensor peak and valley locations.

The fiber Bragg grating (FBG) 102 is a device well known in the art. An FBG has many applications and in this embodiment, the FBG is used to measure temperature. The grating consists of a periodic series of high refractive index—low-refractive index regions within an optical fiber F. These refractive index variations are permanently embedded into the fiber using a special manufacturing process. The period of high-low index variations determines the wavelength reflected by the grating. The spectral reflectance is very well defined as shown in FIG. 2. The peak reflected wavelength is temperature dependent since both the refractive index and spacing of the index variations are functions of temperature. The typical sensitivity of the FBG reflected wavelength with temperature is 11 pm/° C. Using a laser 110 that can be tuned in 8.33 GHz (66.66 pm) steps, the peak reflectance from an FBG as in FIG. 2 can be determined to approximately ±0.5° C.

A diagram of the Fabry-Perot pressure sensor 100 is shown in FIG. 4A. Infrared light from the tunable laser source 110 is transmitted to the sensor 10 through an optical fiber F. The sensor 10 consists of two parallel reflective surfaces 12, 16 separated by a gap G. In one embodiment, the fiber F terminates near a window 12. The first reflective surface of the Fabry Perot cavity 14 is defined by the second surface of a window 12 that is spaced from a diaphragm 16. The second reflective surface of the Fabry Perot cavity is the diaphragm 16. A gap distance G separates the two reflective surfaces 12, 16, which is approximately equal to 95 μm when no pressure is applied. The second surface of the window 12 is coated with a high reflectance (R=80%) dielectric coating and the diaphragm 16 is coated with a similar high reflectance coating (R=80%). The two parallel reflectors 12, 16 separated by gap G comprise a high finesse Fabry-Perot cavity 14. Alternatively, lower reflectances of the two parallel reflectors may be used in a low finesse configuration.

Infrared light reflected from the FBG temperature sensor 102 and FP pressure sensor 100 returns to the signal conditioner (see FIG. 1A) where it is detected by the photodiode detector 120. The detector 120 material is InGaAs, which is sensitive in the infrared wavelength band of interest (1500-1600 nm).

The pressure diaphragm 16 may be for example, a circular steel (e.g., Inconel-718) plate welded around the circumference of the plate to the steel sensor body. When external pressure is applied to the diaphragm 16 it deflects toward the end of the fiber F and the gap G decreases (see FIG. 4A). The radius and thickness of the pressure diaphragm 16 are chosen so that stresses that result are much less than the yield strength of the material. Under these conditions, the deflection D of the center of the diaphragm 16 is a linear function of applied pressure P given by the equation:
D=0.2(Pr⁴)/(Et³) (1)
where:

r is the diaphragm radius

t is the diaphragm thickness

E is Young's modulus of the diaphragm material

For a typical working design:
D=8.2×10⁻⁴ inch (21•m) at P=2000 psi
r=0.3 inch t=0.105 inch
E=29×10⁶ psi
The maximum stress S is given by:

$$\begin{matrix}S = 0.8 ( {Pr}^{2} ) / {t}^{2} \\ = 1.3 \times {10}^{5} psi\end{matrix} \qquad ( 2 )$$

The apparatus is compatible with other pressure sensing means in addition to a flat circular diaphragms. The alternative pressure sensing means include a corrugated diaphragm and low stress pressure sensing configurations such as a pin positioned within a cylindrical tube.

The infrared light intensity reflected back to the signal conditioner 120 from the FP sensor 10 is modulated as the diaphragm 16 deflects and the gap G changes. The ratio of the incident-to-reflected intensity I_{R} is a function of both the laser frequency and the gap G and is given by:

$${I}_{R} ( • , G ) = \frac{F {sin}^{2} [ ( 2 ••G ) / c ]}{1 + F {sin}^{2} [ ( 2 ••G ) / c ]} \qquad ( 3 )$$

where:

c=•• is the velocity of light

•=1.93×10¹⁴ Hz is the frequency of the infrared light

•=1550×10⁻⁹ m (1550 nm) is the wavelength

G is the Fabry-Perot gap distance between the diaphragm and the end of the fiber

F=4R/(1−R)²

R=(R₁R₂)^{1/2} is the composite reflectance of fiber end (R₁) and diaphragm (R₂)

FIG. 3 shows a plot of the reflectance spectrum from the FP sensor 100 versus wavelength calculated using Equation 3. The location of the valleys in the spectrum depends on the gap G between the reflective surfaces R1 and R2. Since R2 is the diaphragm surface 16, G changes with applied pressure. The typical sensitivity of the FP pressure sensor 100 is 2 nm/psi. Using a laser 110 that can be tuned in 8.33 GHz steps, the valleys in the reflectance spectrum (FIG. 3) from the FP pressure sensor 100 can be determined to approximately ±1.5 nm in gap distance. With averaging and additional signal processing, it is possible to determine the gap to better precision.

There are two important reasons to pulse the light source and these are discussed below. First, in long distance applications, the temperature and pressure sensor may be 5 km, 10 km or 15 km away from the interrogator. To ensure that light from the tunable laser 110 reaches the sensor at the end of such long optical fiber cables, high output power is needed. An output power of 1 mW is sufficient and 10 mW is typically available from tunable laser systems. Such large power presents a fundamental problem however. When so much power is injected into the transmission fiber F, light is scattered back to the detector 120. Although the percentage of light scattered back is small, the laser power is large, and the amount of light back-scattered can cause significant detector noise. An optical time domain reflectometer (OTDR) experiences a similar problem, which is why there is a dead band for the first few meters when using an OTDR. The large scattered light signal saturates the detector. One method to minimize or reduce the effects of backscattered light noise is to pulse the light source. The time, t required for light to travel a distance L is given by:
t=nL/c (3a)
where c is the velocity of light and n is the refractive index of the fiber n • 1.5. Over a long transmission fiber length, 10 km for example, t=50 microseconds (μs). Since the FBG and FP sensors 102, 100 are reflective, the light can be can be repetitively switched on, say for 50 μs and then switched off for a longer time period (determined below). When the light is off, there is no backscattering in the fiber F to interfere with sensor signal detection. During the “light-off” interval, the reflected signals from the sensors are detected, analyzed, the light is switched on again for another 50 μs, and the process continues.

A second important reason to pulse the light source is to enable light to be transmitted and returned from the FBG sensor 102 and FP sensor 100 along the same optical fiber F. The FBG sensor 102 reflects a very narrow range of wavelengths, e.g., 1529 to 1532 nm, but the FP sensor 100 is designed to reflect all wavelengths of light emitted by the tunable laser source, e.g., 1529 to 1568 nm. A sharp step filter is not practical for high reflectance dielectric mirrors such as are used to define a Fabry-Perot sensor, which means that it is not practical to multiplex the FBG and FP sensors 102, 100 using wavelength division multiplexing methods only. Time division-multiplexing methods alone or in combination with wavelength division multiplexing can be used to assure the reflected signal from the FP sensor 100 does not interfere with the reflected signal from the FBG sensor 102.

A length of fiber F between the FBG and FP sensors 102, 100 can provide time delay and in combination with a pulsed light source, the interference between the reflected signals from the FBG and FP sensors 102, 100 is eliminated. The fiber F providing time delay may be wrapped into a coil (delay coil, 118) as shown in FIG. 1A. The purpose of the delay coil 118 is to ensure that light reflected from the FBG temperature sensor 102 is detected, analyzed, and the peak position located, before light in the same wavelength band reflected from the FP sensor 100 arrives at the detector 120. The length of the delay coil 118 is determined by several system parameters which include:
The power output level from the tunable laser, the losses in the optical system including fiber transmission loss, connector insertion loss, sensor insertion loss, and InGaAs detector sensitivity all determine how much signal is delivered to the electronics for sampling and processing. The signal level determines the time needed for interrogation and sampling in order to minimize errors due to noise.
Light pulse time duration, which is determined by the sum of the time required to switch on light from the laser light source, interrogate and sample reflected light from the sensor (Item 1 above) and switch off the light.
The switch-on time (300 ns) and switch-off time (300 ns) are determined by the speed of the optical switch 112. However, the on-off repetition rate of the optical switch is limited. Although the optical switch can turn on and turn off in a 600 ns time interval, it cannot be cycled on and off more than 8000 times per second, and the corresponding pulse spacing cannot be any shorter than 1/8000=125 μs.
Time is required to tune the laser 110 from one step to the next over the tuning range. The step rate is 5000 steps per second, so the time between steps is 200 μs. The laser is tuned in 66.66 pm wavelength steps and 600 steps cover the 40 nm tuning range. Thus, the laser can be tuned through the entire tuning range eight times every second. Since the time between successive steps of the laser is 200 μs, the spacing between light pulses cannot be any shorter than 200 μs, and this spacing rather than the 125 μs minimum limit imposed by the optical switch is the true minimum pulse spacing permitted.
For wavelengths used to read the FP pressure sensor 100, the FBG temperature sensor 102 is transparent (e.g. the FBG does not modulate or change the light signal in the wavelength range 1532-1568 nm). Therefore, the pulse width to interrogate the FP pressure sensor 100 can be the full 50 μs as determined by the transit-time-backscatter limit with a 10 km long fiber (see example above and Equation 3a). The FBG temperature sensor 102 is interrogated only when the laser is tuned from 1529-1532 nm. To determine the temperature it is necessary to determine precisely the reflected wavelength (see FIG. 2). During the time period of the FBG scan, the optical switch must be instructed to reduce the width of the light pulse so that there is no interference from the FP pressure sensor 100, which reflects all wavelengths including those between 1529 nm and 1532 nm. The pulse length for the FBG sensor 102 is discussed later.

After consideration of all the items above, the tunable laser 110 can be programmed to step through the tuning range at 5000 steps per second with a 200 μs time interval between steps. After the laser output has settled to a stable value at each wavelength step, the optical switch 112 is turned on to permit light to be transmitted down the fiber F to the sensors FBG, FP 102, 100 (see FIG. 1A).

To interrogate the FP sensor 100 at 10 km, the optical switch 112 is turned on for 50 μis and off for 150 μs and is synchronized to the laser 110 for wavelengths between 1532 and 1568. Similarly, when the FBG sensor 102 is interrogated, the optical switch 112 is synchronized with the laser 110. Light travels about 5 ns/m in optical fiber with refractive index n •1.5. From Equation 3a, a delay coil 118 length of 100 m provides a delay time of 1 μs=1000 μs, which accounts for two trips through the delay coil for light transmitted to and reflected from the FP pressure sensor 100 (see FIG. 1A). A delay time of 1 μs with delay coil 118 length of 100 m ensures that the light reflected by the FBG 102 can be received by the detector 120 and processed before any light at the same wavelength is detected from the FP sensor 100. Since the light level rises during the turn-on time of the optical switch 112 (300 ns) and the light level falls during the turn-off time of the optical switch 112 (300 ns), there are 400 ns in between the rise and fall, when the light level is stable and can be detected, sampled, and processed as shown in FIG. 4B. A delay coil 118 longer than 100 m would enable a longer time for sampling and signal processing.

Alternatively, the reflections from the FBG sensor 102 and FP sensor 100 are separated in time with use of a delay coil 118 (see FIG. 1A). The reflections are also separated in wavelength if the FBG temperature sensor 102 is designed to operate over the wavelength range 1529 nm to 1532 nm. The range of the tunable laser extends to 1568 nm, so the range of the FP pressure sensor 100 can then be 1532 nm to 1568 nm. Separate wavelengths must be dedicated to each sensor because the FBG sensor 102 changes the spectrum of the light presented to the FP sensor 100 in the wavelength range 1529-1532 nm. It is possible to use the measured results from the FBG sensor 102 to compensate for the change in incident light spectrum transmitted to the FP sensor 100 in the 1529-1532 nm range, and the wavelength range for the FP sensor 100 extended for pressure measurement. However, the accuracy for temperature measurement with the FBG sensor 102 is adequate (see FIG. 2), and there is no reason to increase the wavelength range of measurement for the FBG sensor 102. The advantage of increasing the range of the FP pressure sensor 100 is that it would decrease the minimum allowable sensor gap (see FIG. 3 and discussion). Since the maximum change possible is only about 10%, it does not appear to justify the added complexity of the required compensation.

Another alternate embodiment is shown in FIG. 8. In this embodiment, there is no FBG sensor. Instead of a FBG, a second FP 20 is used to measure temperature, and FP 30 is used to measure pressure. A fiber optic power splitter (coupler) 214 transmits light from the laser to both sensors 20, 30 and recombines the reflected light from both sensors 20, 30. As described above, the light from the tunable laser 110 is turned on and off by the optical switch 112. In the FIG. 8 embodiment, all light pulses must be 1 μs long if a 100 meter delay line 118 is used because light at all wavelengths transmitted by the laser (1529-1568) is reflected from both sensors 20, 30. Thus, in this embodiment, the first signal received is reflected from the sensor in the splitter leg without the delay coil. The second signal received is reflected from the other sensor and travels back and forth through the delay coil. The knowledge needed to track each sensor resides in the laser control and signal processing algorithms.

An alternative to separating the signal in time is to dedicate a set of wavelengths within the tuning range to pressure measurement and a different set of wavelengths to temperature measurement. At least one optical filter 24 is needed to limit the reflectance band from the one of the sensors and eliminate any cross-talk. The starting gap for each of the two sensors in this configuration must be increased in inverse proportion to the reduction in the tuning range allocated for each sensor. For example, if the tuning range for the pressure sensor is reduced from 40 nm to 15 nm after allocating bandwidth for the temperature sensor and optical filter, then the starting gap for the pressure sensor must be increased to approximately 300•m to assure the necessary number of interference fringes are observed over the 15 nm tuning range. Likewise the starting gap for the temperature sensor must also increase. Since the resolution and accuracy of the measurement is directly related to the tuning range, it may be appropriate to allocate more of the tuning range to the pressure sensor and less to the temperature sensor.

Another alternate embodiment is shown in FIG. 1B. In this embodiment, there is a 1×3 optical switch 212, which can be connected to any one of three optical channels 201, 202, 203. However, a 1×N optical switch could be used to interrogate N sensors at the ends of N different fiber optic cables. This alternate embodiment enables multiple Fabry-Perot sensors FP#1, FP#2, FP#3 100a, 100b, 100c to be measured with one interrogation system through the use of time division multiplexing. In this embodiment, each channel is scanned in series. The control logic 126 is used keep track of the calibration constants and length of fiber for each channel and the control logic changes the pulse duration and other operating parameters for each channel based on its known configuration.

In general, each sensor is located at a different distance from the interrogator. The pulse duration for each channel would be a function of the actual distance from the signal conditioner unit to each sensor FP#1, FP#2, FP#3 100a, 100b, 100c. Alternatively, the length of fiber used in each channel can be equalized using a separate length of optical fiber F wound into a coil 118 in each channel 201, 202, 203.

In another alternate embodiment, a 2×1 coupler at the output of the 1×1 optical switch 112 may be replaced with a 2×2 coupler. The 2×2 coupler has a second output fiber. If the end of the second fiber is cleaved perpendicular to the fiber axis, a 4% reflected signal returns to the photodiode detector 120. This reflected signal from the second coupler output fiber is detected earlier in time than the signal reflected from a sensor at the end of a long fiber cable. The reflected signal from the coupler can be used to monitor the magnitude of the laser output as a function of time. If necessary, the laser power can be controlled using the reflected signal from the coupler as the feedback signal for control.

In yet another alternate embodiment, FIG. 4B shows an example of a laser pulse that is 1 μs wide. As discussed above, the time delay and separation in time between laser pulses, which is approximately 200 μs. It is straightforward to make the temporal width of the laser pulse adjustable in the electronics, and a 5 μs pulse has been found to work satisfactorily.

The invention has been described above and, obviously, modifications and alternations will occur to others upon a reading and understanding of this specification. The claims as follows are intended to include all modifications and alterations insofar as they come within the scope of the claims or the equivalent thereof.

Having thus described the invention, I claim:

1. An apparatus for making high-resolution measurements at long distances between at least one sensor and the apparatus, said apparatus comprising:
a source providing laser light, said laser light source tunable over a range of frequencies;
an optical switch for pulsing said laser light;
at least one sensor for reflecting said laser light;
a length of fiber optic cable interconnecting said sensor with said laser source;
means for directing the reflected light from said sensor to a detector to generate a digital output; and
a control logic for tuning said laser light source based on said digital output.

2. An apparatus according to claim 1, wherein said laser light pulse can occur for a duration of time with a time interval between said pulses.

3. An apparatus according to claim 2, wherein the duration of said laser light pulse and time interval between said laser light pulse is selectable based on the length of said fiber optic cable.

4. An apparatus according to claim 1, wherein said optical switch is open to pulse said laser light for a duration of less than one half the time interval between optical pulses.

5. An apparatus for making high-resolution measurements at long distances between at least two sensors and the apparatus, said apparatus comprising:
a source providing laser light, said laser light source tunable over a range of frequencies;
an optical switch for pulsing said laser light;
a first sensor for reflecting said laser light;
a second sensor for reflecting said laser light;
a length of fiber optic cable interconnecting said first sensor and said second sensor with said laser light source;
a length of fiber optic cable interconnecting said first sensor and said second sensor wherein said cable delays the reflected light from said second sensor due to the length of said cable;
means for directing the reflected light from said first sensor and the delayed reflected light from said second sensor to a detector to generate a digital output; and
a control logic for tuning said laser light source based on said digital output.

6. An apparatus according to claim 5, wherein said first sensor is a temperature sensor.

7. An apparatus according to claim 6, wherein said temperature sensor is a fiber Bragg grating sensor.

8. An apparatus according to claim 6, wherein said temperature sensor is a Fabry-Perot sensor.

9. An apparatus according to claim 5, wherein said second sensor is a pressure sensor.

10. An apparatus according to claim 9, wherein said pressure sensor is a Fabry-Perot sensor.

11. An apparatus according to claim 5, wherein said detector comprises a photodiode detector, an amplifier, and an analog-to-digital converter.

12. An apparatus according to claim 11, wherein the photodiode detector material is InGaAs.

13. An apparatus according to claim 5, wherein said directing means comprises a coupler.

14. An apparatus according to claim 5, wherein said optical fiber is wrapped into a delay coil.

15. An apparatus according to claim 5, wherein said optical switch switches on and off every 50 microseconds.

16. An apparatus according to claim 5 further comprising a 1×N optical switch which connects N sensors at the ends of N fiber optic cables, which enables multiple sensors to be measured by the apparatus.

17. An apparatus according to claim 5, wherein a 4% embedded reflector is placed along said optical fiber at a known distance (e.g. 100 meters) before said first sensor.

18. An apparatus for making high-resolution measurements at long distances from at least two sensors and the apparatus, said apparatus comprising:
a source providing laser light, said laser light source tunable over a range of frequencies;
an optical switch for pulsing said laser light and directing said laser light into any one of N output channels;
a first sensor for reflecting said laser light connected via a fiber optic cable to a first output channel;
a second sensor for reflecting said laser light connected via a fiber optic cable to a second output channel;
a first length of fiber optic cable interconnecting said first sensor and said first output, and a second length of fiber optic cable interconnecting said second sensor and said second output, wherein said first length is greater than said second length, wherein the difference in length is associated with the delay of the reflected laser light of said first sensor;
means for directing the reflected light from said first sensor and the delayed reflected light from said second sensor to a detector to generate a digital output; and
a control logic for tuning said laser based on said digital output.

19. An apparatus according to claim 18, wherein said first sensor is a temperature sensor.

20. An apparatus according to claim 19, wherein said temperature sensor is a fiber Bragg grating sensor.

21. An apparatus according to claim 19, wherein said temperature sensor is a Fabry-Perot sensor.

22. An apparatus according to claim 18, wherein said second sensor is a pressure sensor.

23. An apparatus according to claim 22, wherein said pressure sensor is a Fabry-Perot sensor.

24. An apparatus according to claim 18, wherein said directing means comprises a coupler.

25. An apparatus according to claim 24, wherein said coupler transmits the light to both sensors and recombines the reflected light from both sensors.

26. An apparatus according to claim 18, further comprising a 1×N optical switch which connects N sensors at the ends of N fiber optic cables, which enables multiple sensors to be measured by the apparatus.

27. An apparatus according to claim 18, wherein said detector comprises a photodiode detector, an amplifier, and an analog-to-digital converter.

28. An apparatus according to claim 18 further comprising at least one optical filter to limit the reflectance from the sensors and eliminate any cross-talk.

29. An apparatus according to claim 18, wherein said optical fiber is wrapped into a delay coil.

30. An apparatus according to claim 19, wherein the output of the temperature sensor can be used to correct the second sensors output for temperature dependent changes in the second sensor.

31. An apparatus according to claim 18, wherein a 4% embedded reflector is placed along said optical fiber at a known distance (e.g. 100 meters) before said first sensor.
